(19) United States
(12) Patent Application Publication
(10) Pub. No.: US 2008/0060390 A1
(43) Pub. Date: Mar. 13, 2008

(54) Padlock with combination lock

(76) Inventors: Chun Te Yu, Fusing Township (TW); Cory O. Nykoluk, Oakdale, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,119

(22) Filed: Nov. 14, 2007

Related U.S. Application Data
(63) Continuation-in-part of application No. 10/671,659, filed on Sep. 29, 2003.

(51) Int. Cl. E05B 37/02

(52) U.S. Cl. 70/21

(57) ABSTRACT

A padlock comprises a shackle, a housing and a combination lock mechanism. The shackle comprises a leg. The housing comprises a first shell and a second shell. The first and second shells co-define a channel for receiving the leg. The first shell has an inner wall formed with a row of first protrusions. The combination lock mechanism comprises a set of teethed sleeves rotatably coupled around the leg of the shackle and a set of numeral wheels rotatably coupled around the teethed sleeves such as to control movements of the leg. The teethed sleeves each defines a first groove corresponding to a respective one of the first protrusions of the first shell. Accordingly, as long as the numeral wheels are dialed to a correct number, all the first grooves of the teethed sleeves are aligned with the first protrusions of the first shell correspondingly so that the leg of the shackle is allowed to move vertically.

### CROSS REFERENCE TO RELATED APPLICATION

This is a continuation-in-part of U.S. Ser. No. 10/671,659, filed on Sep. 29, 2003, currently pending.

### BACKGROUND OF INVENTION

1. Field of Invention

The present invention relates to a padlock and in particular to a padlock having a combination lock mechanism.

2. Related Prior Art

U.S. Pat. No. 6,877,345 discloses a combination and key operated padlock. As shown in FIG. 2 of the U.S. Pat. No. 6,877,345, the padlock includes a housing 110 having opposed front and real walls 112, 114; a U-shaped shackle 120 having a longer leg 126; three identically configured, wheel-like dials 202, 204, 206 carried in spaced parallel-extending slots 212, 214, 216 that are defined by left side regions of the housing; a compression coil spring 145 that engages a lower end region of the longer leg 126 of the shackle 120 when the shackle 120 is locked, so as to bias the shackle 120 upwardly to “pop up” to an unlocked position whenever the padlock 120 is unlocked; three identically configured sleeves 172, 174, 176 that have external teeth that normally engage internal teeth of the three identically configured dials 202, 204, 206; a leaf spring 260 which has three arms 262, 264, 266 that press against the peripheries of the dials 202, 204, 206 to assist in retaining the dials in their current positions; a retaining washer 147 that resides in a groove 137 formed in the longer leg 126 of the shackle 120; and a slide member 270 that has three leftward projecting fingers 272, 274, 276 configured to normally overlie at least some of the teeth 177 of the toothed sleeves 172, 174, 176 and to engage hub portions 179 of the sleeves 172, 174, 176 when the lock is locked. In such a complicated fashion, the housing 10 is provided only for housing the about twenty separately formed parts of the padlock.

### SUMMARY OF INVENTION

The primary object of this invention is therefore to provide a padlock in a sophisticated configuration.

Another object of the invention is to provide an easily assembled padlock.

According to the present invention, a padlock comprises a shackle, a housing and a combination lock mechanism. The shackle has a leg. The housing comprises a first shell and a second shell. The first and second shells co-define a channel for receiving the leg of the shackle. In addition, the first shell has an inner wall formed with a row of first protrusions. The combination lock mechanism comprises a set of teethed sleeves rotatably coupled around the leg of the shackle, and a set of numeral wheels rotatably coupled around the teethed sleeves such as to control movements of the leg. The teethed sleeves each defines a first groove corresponding to a respective one of the protrusions of the first shell. When the numeral wheels are dialed to a correct number to align all the first grooves of the teethed sleeves with the first protrusions of the first shell correspondingly, the leg of the shackle is allowed to move vertically.

In other words, the combination lock mechanism of the present invention is co-operated with both the shackle and the housing to function precisely.

Preferably, the second shell of the housing is further formed with a row of second protrusions so as to be coupled with second grooves defined in the teethed sleeves.

More preferably, the teethed sleeves each further define a furrow in order that the teethed sleeves can be easily placed in a specific order by indications of the furrows.

Further benefits and advantages of the present invention will become clear as the description proceeds.

### BRIEF DESCRIPTION OF DRAWINGS

The invention will now be elucidated with reference to the following description and accompanying drawings where:

FIG. 1 is a perspective view of a padlock according to the preferred embodiment of the present invention;

FIG. 2 is an exploded view of the padlock of FIG. 1;

FIG. 3 is a cross-sectional view of the padlock of FIG. 1;

FIG. 4 is a partly perspective view of the padlock, showing a combination lock mechanism is dialed to a correct number;

FIG. 5 is a cross-sectional view of FIG. 4 taken along a line 5-5, showing a combination lock mechanism of the padlock is dialed to a correct number;

FIG. 6 is a partly perspective view of the padlock, showing the combination lock mechanism is dialed to a wrong number;

FIG. 7 is a cross-sectional view of FIG. 6 taken along a line 7-7, showing the combination lock mechanism is dialed to a wrong number;

### DETAILED DESCRIPTION OF PREFERRED EMBODIMENT

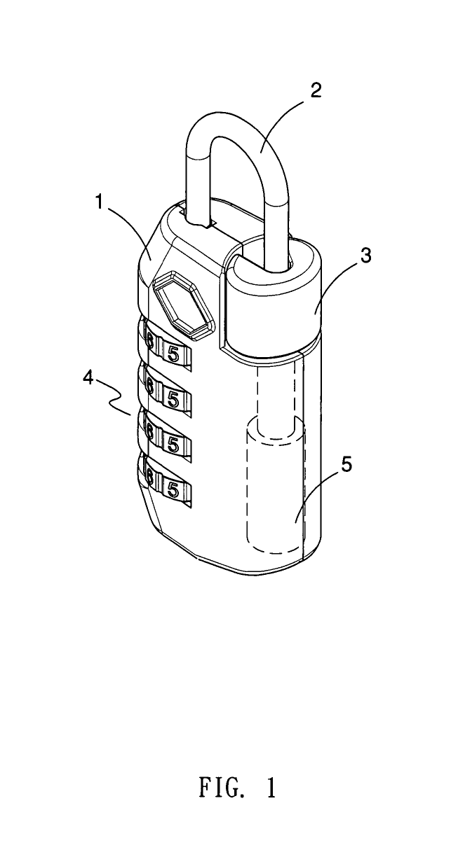

With reference to FIGS. 1 to 5, description will be given of a padlock according to the preferred embodiment of this invention.

Referring now to FIG. 1, the padlock comprises a housing 1, a shackle 2, a block 3, a combination lock mechanism 4, and a key lock mechanism 5.

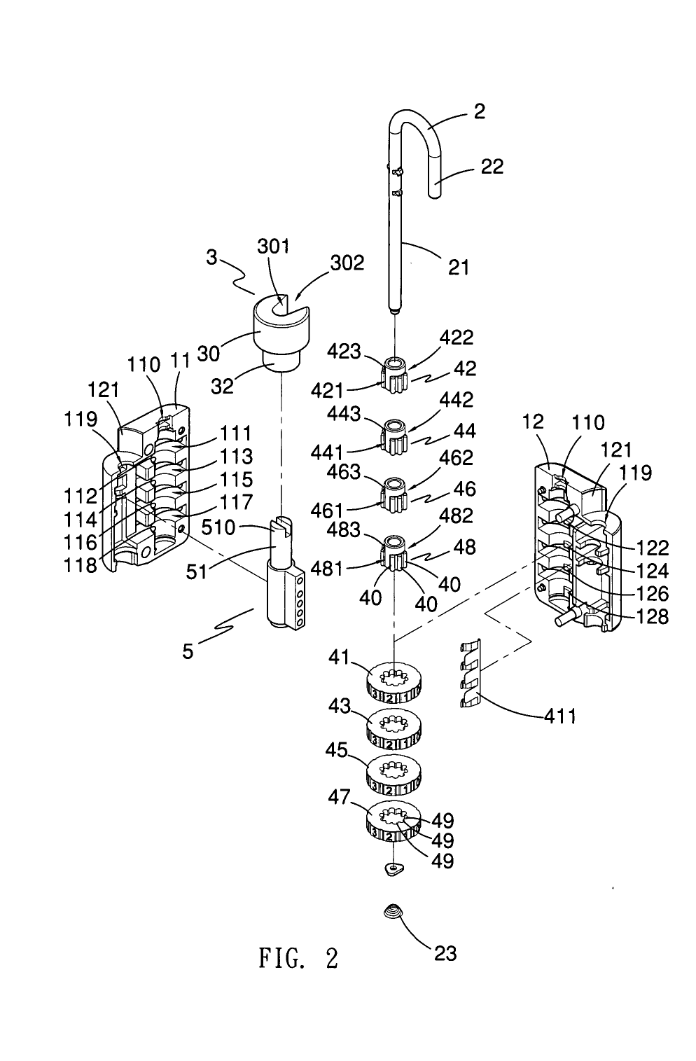

In FIG. 2, the housing 1 is consisted of opposed first and second shells 11, 12, which co-defines a first channel 110 and a second channel 119. The first shell 11 has an inner wall formed with four first protrusions 112, 114, 116, 118. Similarly, the second shell 12 has an inner wall formed with four second protrusions 122, 124, 126, 128.

The shackle 2 has a leg 21 and a relatively short leg 22. The leg 21 is received in the first channel 110 of the housing 1.

The combination lock mechanism 4 is provided to control movements of the leg 21 of the shackle 2 and includes four identical teethed sleeves 42, 44, 46, 48 and four identical numeral wheels 41, 43, 45, 47 carried in spaced parallel-extending slots 111, 113, 115, 117 that are defined in the shells 11, 12. The sleeves 42, 44, 46, 48 have external teeth 40 that normally engage with internal teeth 49 of the numeral wheels 41, 43, 45, 47. Moreover, the sleeves 42, 44, 46, 48 are rotatably coupled around the leg 21 of the shackle 2. In such a feature, the sleeves 42, 44, 46, 48 is allowed to move with the leg 21 of the shackle 2 when the numeral wheels 41, 43, 45, 47 are dialed to a correct number.

More specifically, the teethed sleeves 42, 44, 46, 48 define first grooves 421, 441, 461, 481 corresponding to the first protrusions 112, 114, 116, 118 of the first shell 11, and second grooves 422, 442, 462, 482 corresponding to the second protrusions 122, 124, 126, 128 of the second shell 12. The combination lock mechanism 4 further comprises a leaf spring 411 which has four arms that press against the peripheries of the numeral wheels 41, 43, 45, 47 to assist in retaining the numeral wheels 41, 43, 45, 47 in their current positions. In such a feature, as long as the numeral wheels 41, 43, 45, 47 are dialed to the correct number in order that all the first grooves 421, 441, 461, 481 of the teethed sleeves 42, 44, 46, 48 are aligned with the first protrusions 112, 114, 116, 118 of the first shell 11 and all the second grooves 422, 442, 462, 482 are aligned with the second protrusions 122, 124, 126, 128 of the second shell 12, the leg 21 of the shackle 2 is allowed to move vertically.

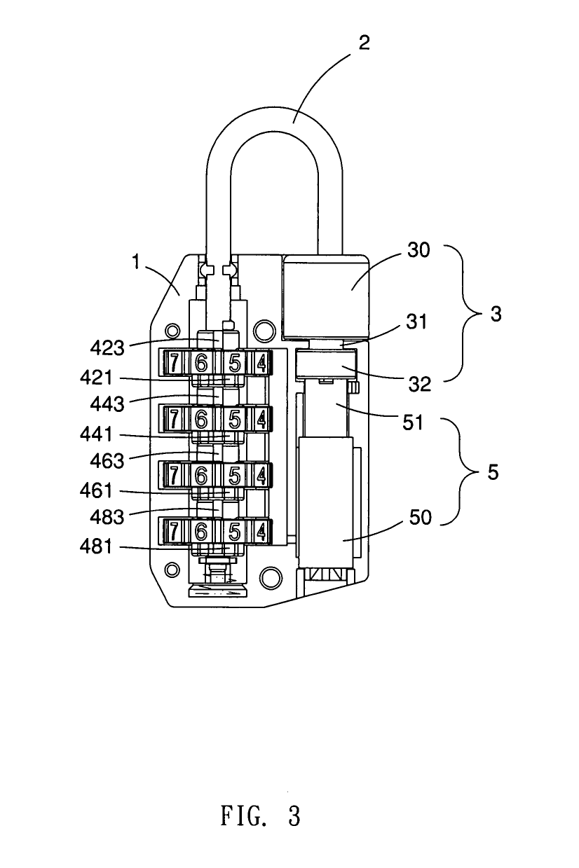

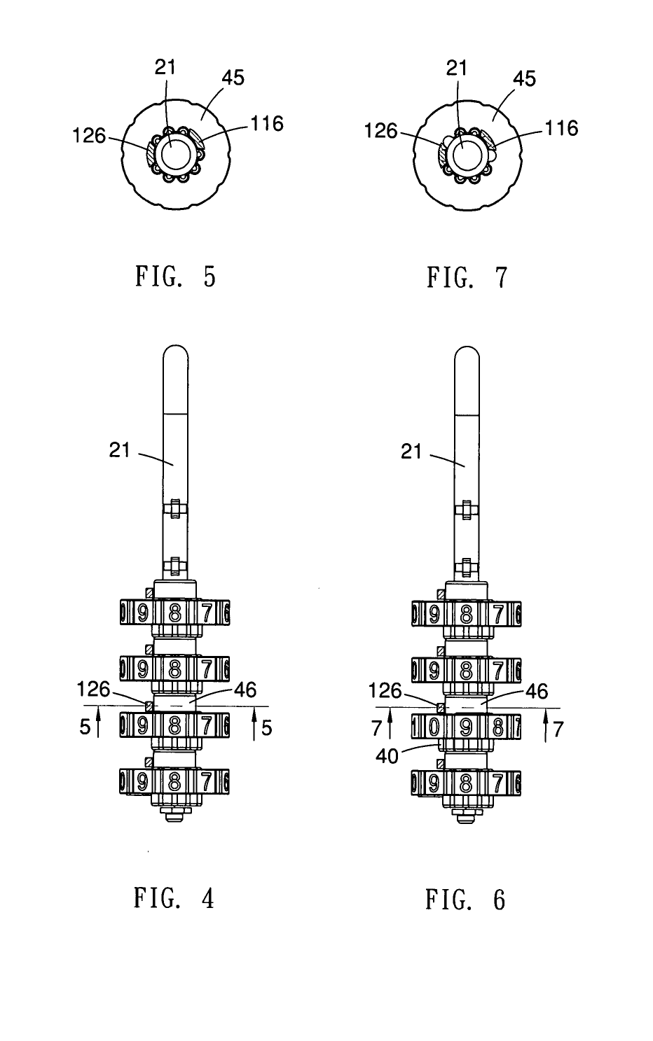

Referring to FIG. 3, the teethed sleeves 42, 44, 46, 48 have hub portions defining furrows 423, 443, 463, 483 in order that the teethed sleeves 42, 44, 46, 48 can be efficiently placed in a specific order by indications of the furrows 423, 443, 463, 483. More specifically, the furrows 423, 443, 463, 483 are configured to be able to be arranged in a row such that the first and second grooves of the teethed sleeves 42, 44, 46, 48 are right aligned with the first and second protrusions of the shells 11, 12. In other words, an assemblyman just needs to arrange the furrows of the teethed sleeves 42, 44, 46, 48 in the row as depicted in FIGS. 4 and 6 such that the teethed sleeves 42, 44, 46, 48 are right in the specific order immediately, which defines the correct number of the set of numeral wheels 41, 43, 45, 47. On the contrary, if the numeral wheels 41, 43, 45, 47 are dialed to a wrong number as depicted in FIGS. 6 and 7, the leg 21 can not move vertically, inasmuch as some of the teeth 40 of the sleeve 46 are blocked by the protrusion 126 of the shell 12.

Referring back to FIG. 2, the padlock further comprises a spring 23 disposed at and end of the leg 21 of the shackle 2 so that the numeral wheels 41, 43, 45, 47 can be reset while pressing the leg 21 of the shackle 2 against the spring 23 as long as the numeral wheels 41, 43, 45, 47 are dialed to the correct number.

As can be seen in FIGS. 2 and 3, the block 3 comprises a button 30, a neck portion 31 and a mounting portion 32. The button 30 defines a receptacle 301 in a top and a gap 302 in a side. The receptacle 301 and the gap 302 are in communication with each other and provided for the relatively short leg 22 to be engaged with. That is, the short leg 22 can be released either through the receptacle 301 or the gap 302. In this preferred embodiment, once the numeral wheels 41, 43, 45, 47 are dialed to the correct number so as to allow the leg 21 of the shackle 2 move vertically, the relatively short leg 22 can be removed from the receptacle 301. The gap 302 has a width larger than the diameter of the short leg 22. The button 30 of the block 3 can be rotated to a first position where the gap 302 faces walls 121 of the first and second shells 11, 12 for blocking the end of the short leg 22, and to a second position where the gap 302 is exposed for releasing the short leg 22. The neck portion 31 is received in the second channel 119 of the housing 1 to connect the button 30 and the mounting portion 32. The diameter of the neck portion 31 is smaller than each of the diameters of the button 30 and the mounting portion 32.

The key lock mechanism 5 is installed in the housing 1 for controlling movements of the block 3 in order the block 3 to be engaged with or disengaged from the relatively short leg 22 of the shackle 2. The key lock mechanism 5 comprises a body 50 and a rotor 51 partly received in the body 50. The rotor 51 includes a driving portion 510 at a top end for driving the mounting portion 32 of the block 3. The rotor 51 defines a keyhole (not shown) at a bottom end thereof for being engaged with a key (not shown). In such a feature, the key can be operated by a user to rotate the rotor 51 and indirectly to drive the block 3 to the second position where the gap 302 is exposed and the short leg 22 can be removed from the gap 302.

As disclosed above, the dual-locking padlock of the present invention mainly relies on the cooperation of the housing 1, the shackle 2 and the combination lock mechanism 4 and exhibits advantages of easy production without losing the precise configuration because of the furrows 423, 443, 463, 483.

Numerous characteristics and advantages of the invention have been set forth in the foregoing description. The disclosure, however, is illustrative only, and changes may be made in detail within the principle of the invention, to the full extent indicated by the broad general meaning of the terms in which the appended claims are expressed.

1. A padlock comprising:
a shackle comprising a leg;
a housing comprising a first shell and a second shell; the first and the second shells co-defining a channel for receiving the leg; and the first shell having an inner wall formed with a row of first protrusions;
a combination lock mechanism comprising a set of teethed sleeves rotatably coupled around the leg of the shackle and a set of numeral wheels rotatably coupled around the teethed sleeves so as to control movements of the leg, wherein the teethed sleeves each defines a first groove corresponding to a respective one of the first protrusions of the first shell such that when the numeral wheels is dialed to a correct number to align all the first grooves of the teethed sleeves with the first protrusions of the first shell correspondingly, the leg of the shackle is allowed to move vertically.

2. The padlock of claim 1 wherein the second shell has an inner wall formed with a row of second protrusions, and the teethed sleeves each defining a second groove corresponding to a respective one of the second protrusions such that when all the first grooves of the teethed sleeves are aligned with the first protrusions of the first shell and all the second grooves of the teethed sleeves are aligned with the second protrusions of the second shell correspondingly so as to turn the numeral wheels to the correct number, the leg of the shackle is allowed to move vertically.

3. The padlock of claim 1 wherein the teethed sleeves each has a hub portion defining a furrow according to the first grooves so as to guide the teethed sleeves being placed in a specific order by indications of the furrows.

4. The padlock of claim 3 wherein when the furrows are arranged in a row, the first grooves of the teethed sleeves are right aligned with the first protrusions of the first shell correspondingly.

5. The padlock of claim 1 further comprising:
a block connected to the housing; and
a locking unit installed in the housing for controlling movements of the block to block or release a relatively short leg of the shackle.

6. The padlock of claim 5 wherein the locking unit is a key lock mechanism.

7. The padlock of claim 1 further comprising a spring disposed at and end of the leg of the shackle so that the numeral wheels can be reset while pressing the leg of the shackle against the spring.
